(19) United States
(12) Patent Application Publication
(10) Pub. No.: US 2016/0356917 A1
(43) Pub. Date: Dec. 8, 2016

(54) CHEMICAL SENSING USING QUANTUM ENTANGLEMENT BETWEEN PHOTONS

(71) Applicant: Halliburton Energy Services, Inc., Houston, TX (US)

(72) Inventor: Satyan Gopal Bhongale, Houston, TX (US)

(21) Appl. No.: 14/733,368

(22) Filed: Jun. 8, 2015

(51) Int. Cl. G01V 8/02

(52) U.S. Cl. CPC G01V 8/02

(57) ABSTRACT

Various embodiments include systems and methods of sensing implemented by utilizing quantum entanglement between photon states. An approach to sensing may include generating entangled pairs of photons, sending photons of the entangled pairs in a detection direction and other photons of the entangled pairs in a sensing direction, and analyzing statistics of detected photons with respect to an entanglement characteristic. Additional systems and methods are described that may be used in a variety of applications.

### TECHNICAL FIELD

The present invention relates generally to apparatus and methods with respect to performing measurements.

### BACKGROUND

In drilling wells for oil and gas exploration, understanding the structure and properties of the geological formation surrounding a borehole provides information to aid such exploration. However, the environment in which the drilling tools operate is at significant distances below the surface and measurements to manage operation of such equipment are made at these locations. An important parameter to measure downhole at a well site is the presence of particular chemicals. Further, the usefulness of such measurements may be related to the precision or quality of the information derived from such measurements.

### BRIEF DESCRIPTION OF THE DRAWINGS

FIGS. 1A-1C are representations of entangled photons generated via a non-linear crystal, in which outgoing photons are entangled in frequency, in accordance with various embodiments.

FIG. 2 is a representation of polarization entangled photons, in accordance with various embodiments.

FIG. 3 is a block diagram of an example system arranged as a measurement system using entangled photons, in accordance with various embodiments.

FIG. 4 is a flow diagram of an example method of measurement using entangled photons, in accordance with various embodiments.

FIG. 5 is a flow diagram of an example method of measurement using entangled photons with respect to frequency, in accordance with various embodiments.

FIG. 6 is a schematic of an example sensing scheme to detect one or more chemicals downhole at a well site, in accordance with various embodiments.

FIG. 7 is a block diagram of a system including components to detect an entity using entangled photons, in accordance with various embodiments.

### DETAILED DESCRIPTION

The following detailed description refers to the accompanying drawings that show, by way of illustration and not limitation, various embodiments in which the invention may be practiced. These embodiments are described in sufficient detail to enable those skilled in the art to practice these and other embodiments. Other embodiments may be utilized, and structural, logical, and electrical changes may be made to these embodiments. The various embodiments are not necessarily mutually exclusive, as some embodiments can be combined with one or more other embodiments to form new embodiments. The following detailed description is, therefore, not to be taken in a limiting sense.

In various embodiments, apparatus and methods of chemical sensing are implemented utilizing quantum entanglement between photon states. Such an approach to chemical sensing allows for detecting chemicals in harsh environments such as downhole at a well site with no downhole electronics, and minimal additional optical components. The discrimination between different chemicals may be done spectroscopically, for example by absorption spectroscopy.

Quantum entanglement is a physical phenomenon that occurs when pairs or groups of particles are generated or interact in a manner such that the quantum state of each particle cannot be described independently. Rather, a quantum state may be given for the combined pairs or groups of photons as a whole. Measurements of physical properties or characteristics performed on individual particles of the entangled system are found to be correlated with each other. The characteristics can include but are not limited to characteristics such as position, momentum, spin, polarization, etc. For example, if a pair of entangled particles is generated in such a way that their total spin is known to be zero, and one particle is found to have clockwise spin on a certain axis, then the spin of the other particle, measured on the same axis, will be found to be counterclockwise. Another example could be polarization entangled photons. If a pair of photon is created in an entangled state such that their polarizations are orthogonal, then, on measurement if one of the photons is found in, for instance, the horizontal polarization, then the other photon has to be in the vertical polarization. However, the important distinction between classical systems and quantum entanglement is that the individual state of polarization of the photons is not determined until a measurement is performed. With respect to quantum measurements, any measurement of a property of a particle can be seen as acting on that particle, for example, by collapsing a number of superimposed states; and in the case of entangled particles, such action must be on the entangled system as a whole. It is apparent that one particle of an entangled pair essentially is aware of what measurement has been performed on the other including its outcome, even though there appears to be no means for such information to be communicated between the particles, which at the time of measurement may be separated by arbitrarily large distances. In various embodiments taught herein, entangled light states can be implemented.

Consider entanglement in photons. A quantum state of a photon can be symbolically represented by some state, |ψ(1)>. This state can be constructed from a superposition between different orthogonal states, just like any vector in Cartesian coordinates. This state can be written as a sum of vectors pointing in the orthogonal directions, x, y, and z. In terms of orthogonal states of the photon

|ψ(1)>=c_{α}|α>+c_{β}|β>

where |α> and |β> are the orthogonal basis states of the photon. If there are two indistinguishable photons, then the state is written as a “symmetric” sum of product of states of individual photons. Here, the symmetry is important and is a fundamental fact.

$${{{\vert ψ ( 2 ) 〉 = {\sum }_{αβ} {\{ {c}_{αβ} \vert α 〉}_{1} \vert β 〉}_{2} + {c}_{βα} \vert β 〉}_{1} \vert α 〉}_{2} \}$$

In the above c_{αβ}=c_{β+}.

Entanglement means is that, if one measures a first photon in state, |α>, then the second is guaranteed to be in state |β> with probability 1, no matter how far they are located from each other. Note however that, this does not imply that the state of the first photon was |α> and that of second was |β> to begin with before measurement, because that would mean a state |ψ(2)>=|α>₁|β>₂ and not the states written above. When a measurement is made on the first photon, the state of the photon collapses to |α> in a probabilistic way, which triggers the second photon to collapse to the states |β>. The state of the photons before measurement is undetermined.

While the idea of quantum entanglement is rooted in Quantum Theory, it is no longer a theoretical concept. Entanglement has been proved to be valid and has been already demonstrated experimentally in photons, atoms, microwave radiation, and nano diamonds. Entangled photons have been transported via fibers to a distance of several kilometers without loss of entanglement. Entanglement has been used for cryptography and such devices are available off the shelf.

Additionally, two photons maybe entangled in several different ways, depending on how the physical mechanism of generation. They could be entangled with respect to their polarization states, or energy states, or even time of generation state.

Consider the generation of entangled photons. A nonlinear crystal can used to split photons into pairs of photons that have combined energies and momenta equal to the energy and momentum of the original photon, are phase-matched in the frequency domain, and have correlated polarizations. The splitting is conducted in accordance with the law of conservation of energy and the law of conservation of momentum. The photons are entangled in frequency space. The state of the photon can be written as

$${{\vert ψ ( 2 ) 〉 = {\sum }_{{ω}_{i}} {α}_{i} \vert {ω}_{i} 〉}_{1} \vert {ω}_{pump} - {ω}_{i} 〉}_{2}$$

where ωₚᵤₘₚ is the frequency of the optical source that generated the photons, which can typically be a pump laser. This means that, if one of the photons, which can be called the signal photon, has frequency ωₛ, then the other photon, which can be called the idler, is guaranteed to have frequency ωᵢ=ωₚᵤₘₚ−ωₛ. Again, it is herein emphasized that the frequency of photons is not determined a priori, that is, before measurement.

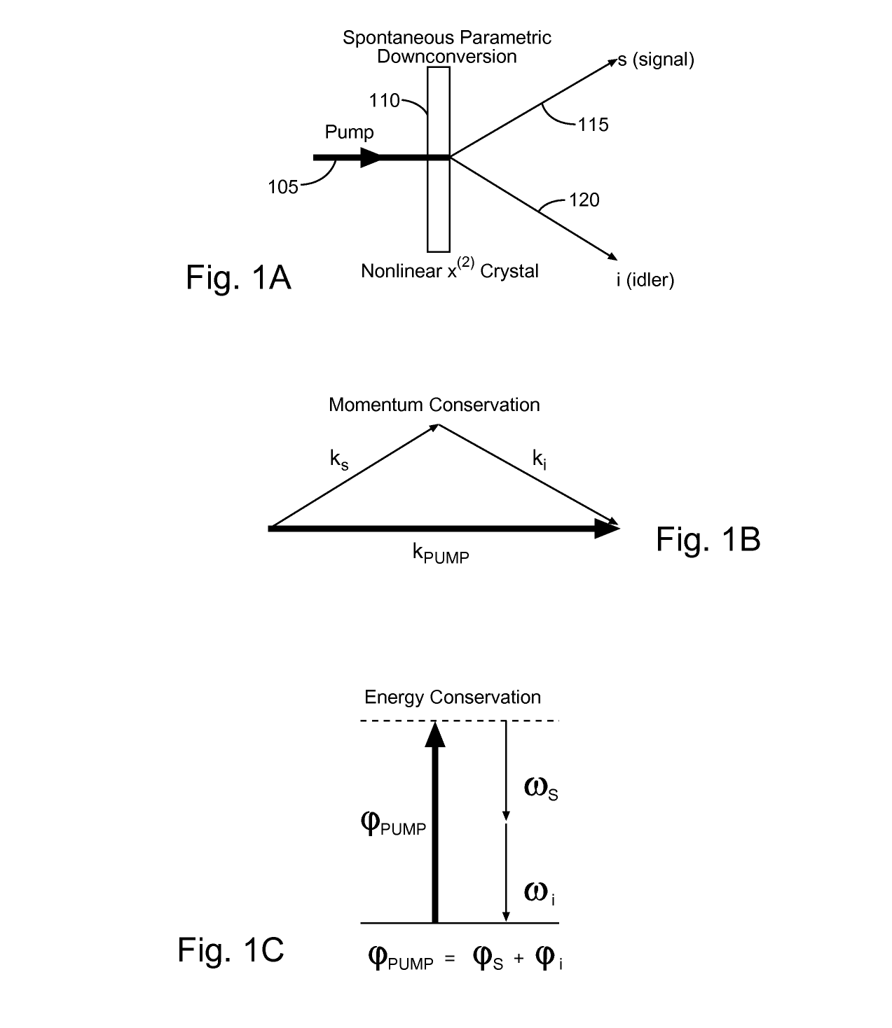

FIG. 1A is a representation of the generation of entangled photons via a non-linear crystal. The outgoing photons are entangled in frequency. A pump beam 105 is input to a nonlinear crystal 110, having a second-order nonlinear polarization χ⁽²⁾, that can generate spontaneous parametric down-conversion (SPDC) providing the signal 115 and the idler 120. FIG. 1B is a representation of momentum conversion between the momentum of the pump, kₚᵤₘₚ, the momentum of the signal, kₛ, and the momentum of the idler, kᵢ. FIG. 1C is a representation of energy conversion between the pump, the signal, and the idler in terms of pump frequency, ω_{pump,} idler frequency, ωᵢ and signal frequency, ωₛ. Phase-matching in the frequency domain is also shown in FIG. 1C by φₚᵤₘₚ=φₛ+φᵢ, where φₚᵤₘₚ is the phase of the pump, φₛ, is the phase of the signal, and φᵢ is the phase of the idler.

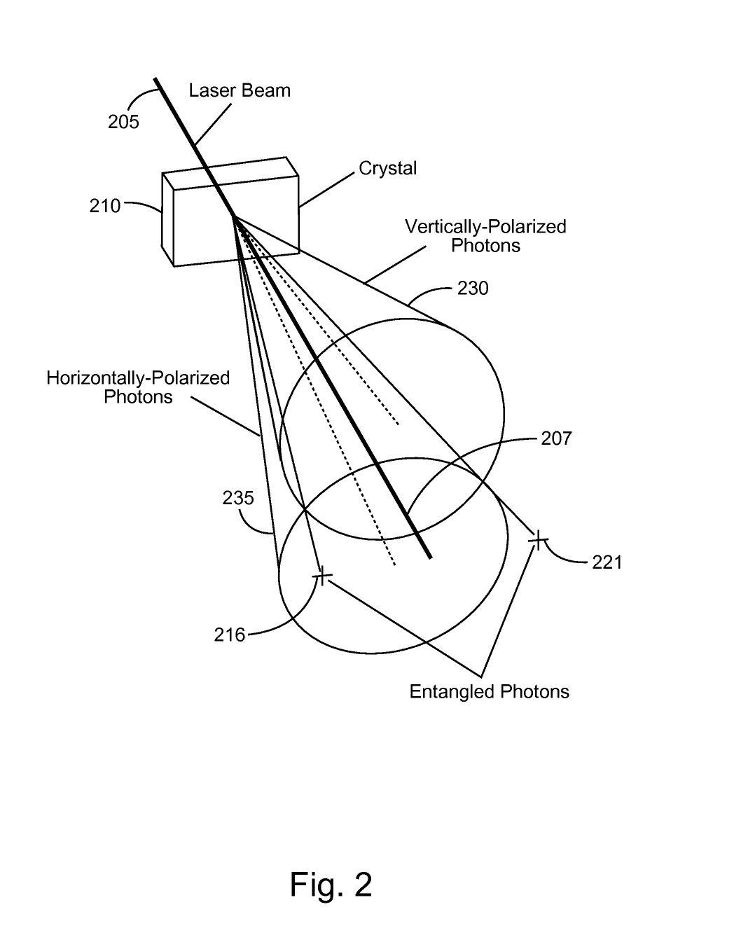

FIG. 2 is a representation of polarization entangled photons 216 and 221. A laser beam 205 incident on a crystal 210 can result in the generation of entangled photons 216 and 221. In commonly used apparatus, a relatively strong laser beam 205, referred to as a pump, can be directed towards the crystal 210 such as a beta barium borate crystal (BBO). Most of the photons continue straight through the crystal 210 as shown by the direction 207 in FIG. 2. Occasionally, some of the photons undergo spontaneous down conversion into the two entangled photons 216 and 221. Cones of vertically-polarized photons 230 and horizontally-polarized photons 235 may be generated in which the cones have axes symmetrically arranged relative to the pump beam. If the entangled photons have the same polarization, the photons are referred to as type 1 photons, and if the entangled photons have opposite polarization, the photons are referred to as type 2 photons. A BBO crystal produces type 2 photons. Another crystal, potassium dihydrogen phosphate (KDP), can produce type 1 photons. Recent published experiments have demonstrated generation of entangled photons in the telecom band.

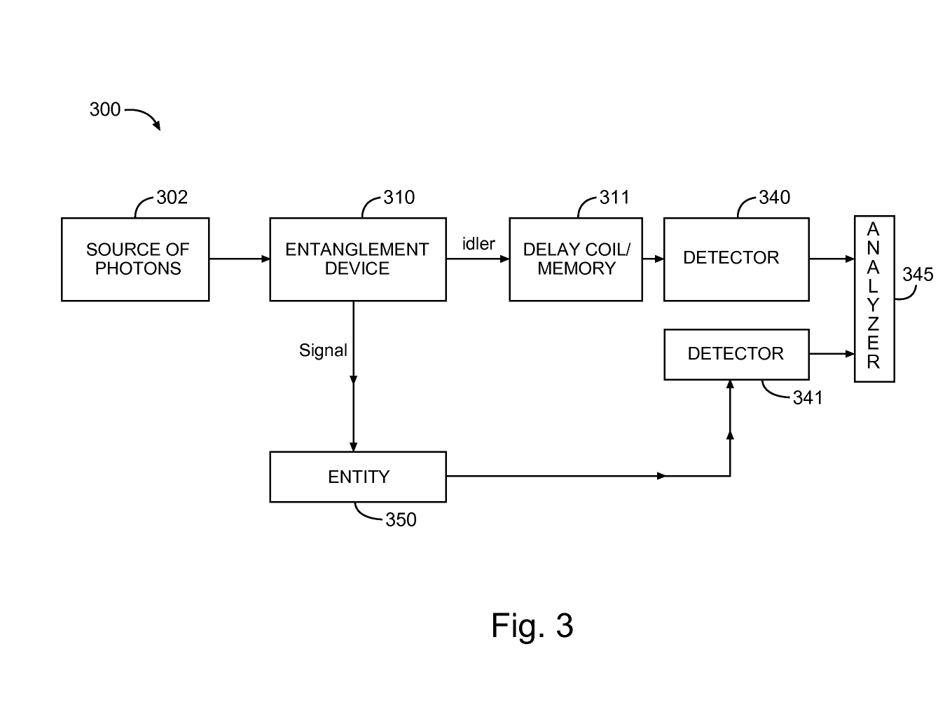

FIG. 3 is a block diagram of an embodiment of an example system 300 arranged as a measurement system using entangled photons. The system 300 can include a source of coherent photons 302, an entanglement device 310 arranged to receive photons from the source of photons 302 and to generate entangled pairs of photons, entangled with respect to a suitable characteristic of the photons appropriate for the downhole property to be measured, and a detector 340 arranged to receive one of the photons of the entangled pair, typically referred as the idler photon. The detector 340 may be preceded by a device 311 that provides appropriate delay such as a photon memory or a delay coil. The entanglement device 310 may include, but is not limited to, a non-linear crystal to generate the entangled photons, nonlinear wave guides, and/or combinations of them. Furthermore, to generate entangled pairs of the right characteristics, the entanglement device may further include optical components such as but not limited to mirrors, dichroic mirrors, ordinary reflectors as well as beam splitters, filters, resonant cavities, Bragg gratings, couplers, etc.

The second photons of entangled pairs from the entanglement device 310 can be directed to an entity 350 that is being investigated. Entity 350 under investigation provides a mechanism to attenuate or alter the photon characteristic being used with respect to the entanglement of the photons. The altered photons are detected. Altered photons may constitute only part of the total number of photons sent to the entity 350 in the form of reflected or transmitted photons, which are then detected by the detector 341. The detectors 340 and 341 may further detect only the energy, phase, and/or the polarization of photons received by them. An analyzer 345 can be arranged with the detectors 340 and 341 to determine statistics and/or correlations of photons detected at the detectors 340 and 341, and to identify presence or absence of the entity 350 from the correlation/statistics. Optionally, detectors 340, 341, and analyzer 345 may be an integrated unit.

A number of different characteristics of the entangled photons may be examined in a measurement made using the system 300. The characteristic of the entangled photons examined in the system 300 can be polarization of the photons and the detectors 340 and 341 can be selected to be operable to detect polarization of received photons. The characteristic of the entangled photons examined in the system 300 can be frequency of the photons and the detectors 340 and 341 can be selected to be operable to detect frequency of the received photons at detectors 340 and 341. The entanglement device 310 can be structured to generate frequency entangled pairs of photons with a plurality of different pairs of frequencies, at least one pair of frequencies correlated to identifying presence or absence of a chemical different from the chemical identified using one of the other entangled pairs of photons. For example, the entanglement device 310 may be structured to generate N different pairs of frequencies, where the N different pairs of frequencies can be used to sense the presence or absence of M different chemicals. M may be one or larger than one.

The system 300 can include an optical fiber to propagate the photons of the entangled pairs in the direction to sense the entity 350, where entity 350 may be one of a number of chemicals or a composition including one or more chemicals such as a structure with contamination disposed thereon. Such an optical fiber can be disposed downhole in a well to sense the presence or absence of a chemical in the well. A cladding of the optical fiber at a location of sensing can be structured to adsorb the chemical such that photons of a frequency corresponding to the chemical are lost. The loss may be due to absorption based on the presence of the chemical. Alternatively to the chemical or chemicals being sensed in the optical fiber, or in conjunction with such an optical fiber, the system 300 can include a sensor disposed downhole and coupled to the optical fiber, where the sensor can be structured to produce attenuation at a specific frequency if the chemical is present or reflect the signal if the chemical is present, the specific frequency being a frequency of the photons of the frequency entangled pairs sent in a direction to sense the chemical. Furthermore, the photons collected after the entity 350 may be those that are transmitted or reflected by the entity 350 which are then detected by the detector 341.

In addition, an optical fiber may be arranged to propagate the other photon of the entangled pair to the detector 340. The system 300 can include a delay structure 311 arranged to delay propagation of the other photons to the detector 340 for a period to permit interaction of the chemical, if present, with the photons sent in the direction to sense the chemical prior to detection of the other photons at detector 340. A delay structure may be realized by an optical delay coil or other optical device to adjust propagation length. Alternatively the delay could be achieved by storing the photon in a photonic memory, and only allowing the photon to exit the memory when needed for detection.

With entity 350 being a chemical under investigation, the identification of the presence or the absence of the chemical from the statistics can include a calculation and comparison of probability of detected photons having a frequency same and different from frequency attenuated by the chemical at the detectors 340 and 341. With photons of a given frequency attenuated or absorbed by the chemical, from examining the photons at the detector 340, the percentage of the detected photons having a frequency corresponding to the other frequency of the entangled photons should be 100%.

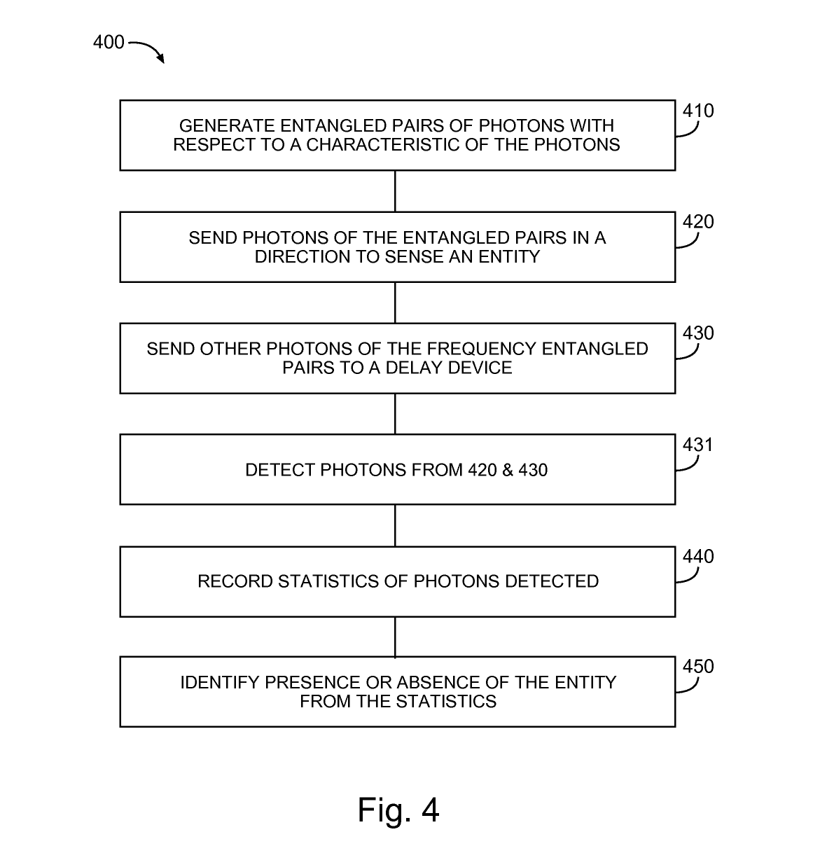

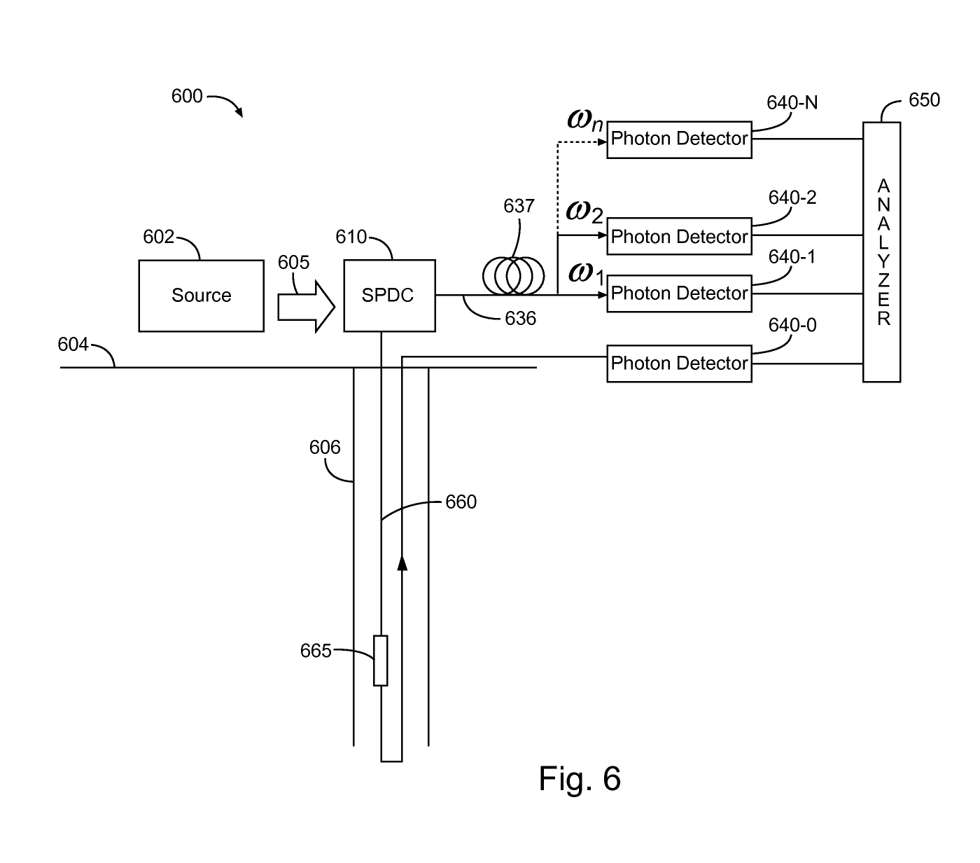

FIG. 4 is a flow diagram of an embodiment of a method 400 of measurement using entangled photons. Such a method may be implemented using a system similar to or identical to one or more systems as discussed with respect to FIGS. 3 and 6. At 410, entangled pairs of photons with respect to a characteristic of the photons generated. Generating entangled pairs of photons can include generating entangled pairs of photons with respect to polarization. Other characteristics of the photons may be used with respect to entanglement related measurements. At 420, photons of the entangled pairs are sent in a direction to sense an entity. The entity may be one or more chemicals. The direction may be in a direction below earth surface. At 430, other photons of the entangled pairs are sent to a delay device. The delay device may be disposed on the earth surface. At 431 the photons corresponding to step 420 and 430 are detected. At 440, statistics of photons detected are recorded. Recording statistics of photons detected at the detector can include determining the number of photons detected that have a specific frequency with respect to the total number of photons detected. Photon correlations between the photon of the entangled pair sent to a detector on the earth surface, and the other photon that was sent downhole and returned back to the earth surface can be analyzed. At 450, presence or absence of the entity is identified from the statistics.

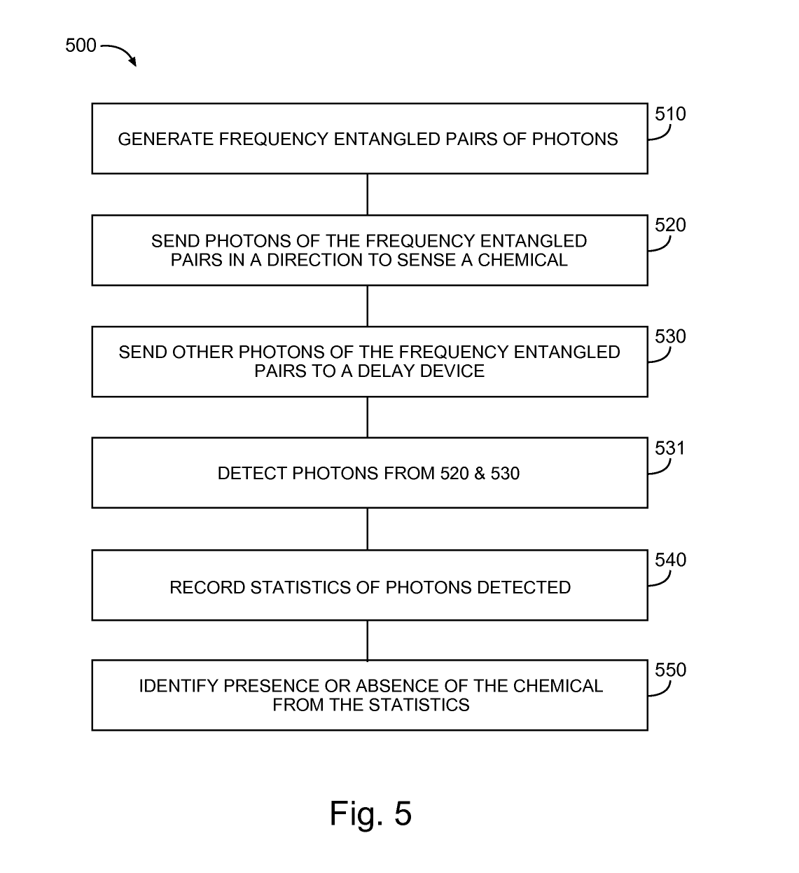

FIG. 5 is a flow diagram of an embodiment of a method 500 of measurement using entangled photons with respect to frequency. Such a method may be implemented using a system similar to or identical to one or more systems as discussed with respect to FIGS. 3 and 6. At 510, frequency entangled pairs of photons are generated. Generating frequency entangled pairs of photons can include generating frequency entangled pairs of photons with a plurality of different pairs of frequencies, at least one pair of frequencies correlated to identifying presence or absence of a chemical different from a chemical identified using one of the other entangled pairs of photons.

At 520, photons of the frequency entangled pairs are sent in a direction to sense a chemical. Sending photons of the frequency entangled pairs in the direction to sense the chemical can include sending the photons into an optical fiber disposed downhole in a well in the direction to sense the chemical. The cladding of such an optical fiber at a location of sensing can be structured to adsorb the chemical such that photons of a frequency corresponding to the chemical are lost. Sending the photons into the optical fiber can include sending the photons to a sensor disposed downhole and coupled to the optical fiber, the sensor structured to produce enhanced attenuation at a specific frequency if the chemical is present, or enhanced reflectivity at a specific frequency if the chemical is present, the specific frequency being a frequency of the photons of the frequency entangled pairs sent in a direction to sense the chemical. The downhole arrangement of a sensing optical fiber and/or sensor maybe implemented in a wireline arrangement, in a measurements-while-drilling (MWD) arrangement such as a logging-while-drilling (LWD) arrangement, or in another downhole measurement arrangement. These photons may be passing through the region where the presence of the chemical is to be detected. These photons, as transmitted or reflected photons, may be guided from the sensing region back to the earth surface via the same fiber or a different fiber using a circulator or a coupler to guide the photon back to the earth surface.

At 530, other photons of the frequency entangled pairs are sent to an optical delay device. Delaying the propagation of the other photons to the detector can be conducted for a period to permit interaction of the chemical, if present, with the photons sent in the direction to sense the chemical prior to detection. Delaying the propagation can include sending the other photons to the detector using an optical delay coil. Delaying the propagation can include producing the delay by slowing the other photons down using a slow light device. The slow light device may use a nonlinear interaction. Delaying the propagation can include sending the other photons to the detector using an optical memory. The optical memory may be a cavity or a solid state memory. From the optical delay device, these photons propagate to one or more detectors.

At 531, the photons from step 520 and 530 are detected for statistical analysis. At 540, statistics of photons detected are recorded. At 550, presence or absence of the chemical is identified from the statistics. Identifying the presence or the absence of the chemical from the statistics can include calculating a probability of detected photons having a frequency different from frequency attenuated by the chemical.

Chemical sensing using entangled photons can employ frequency entangled photons in various embodiments. A frequency entangled pair of photons can be generated with one photon of the entangled pair being sent in the direction where the chemical is to be sensed. For example, for downhole sensing, the photon can be sent via a fiber. The second photon of the entangled pair can be retained on the surface at the well site. This second photon may be set in another fiber that is located on the surface.

The downhole fiber can be designed such that the cladding of the fiber at the location of sensing adsorbs the chemical to be sensed, resulting in loss of photons at the location of sensing. Furthermore, only photons of a certain frequency corresponding to the chemical to be sensed will be lost out of the fiber. The fiber cladding can be designed such that different chemicals will lead to loss at different frequencies.

The frequency of photons on the surface can be measured. This measurement can be performed after the downhole photon has passed through the sensing region. Passing through the sensing region includes absorption or attenuation by the chemical or chemicals, if present. This timing can be achieved by using an optical delay coil on the surface.

The probability of photons to have a frequency ω_{j,} P(ωⱼ), can be obtained from measuring several photons. Determining the probability of detected photons having frequency ωⱼ can be realized by determining the amount (frequency of detection) of the photons detected that are at frequency ωⱼ from among the photons detected. If presence of chemical-A leads to the loss of photon of frequency ω_{A} downhole, then the surface photon is guaranteed to be in frequency ωₚᵤₘₚ−ω_{A}, with unit probability. However, if there is no chemical-A present at the sensing location, the probability of surface photon to be at frequency ωₚᵤₘₚ−ω_{A} is ½. The precise frequency of the lost photon is not required, only the knowledge that it is lost is important. The frequency determined by analyzing the statistics of photon retained on the surface is required in this embodiment.

Thus, by recording the statistics of the photon on the surface, presence or absence of downhole chemicals can be determined Even if there is loss of photons by other mechanisms, that will affect all frequencies to approximately the same extent, thus the surface probability will remain close to ½ except when the chemical is present.

FIG. 6 is a schematic of an embodiment of an example sensing scheme 600 to detect one or more chemicals downhole at a well site. The sensing scheme 600 may be structured and arranged in a manner identical to or similar to features discussed with respect to FIGS. 1-5. The sensing scheme 600 can include a source 602 arranged to direct a beam 605 to a photon entanglement device 610. The source 602 can be a pump laser. The photon entanglement device 610 may be realized as but not limited to a SPDC device. Entangled photons can be transmitted into an optical fiber 660 disposed downhole in a well 606 from the surface 604, while corresponding photons of the entangled photons remain above the surface 604 and are transmitted to one or more detectors 640-1, 640-2, . . . 640-N. The detectors 640-1, 640-2, . . . 640-N can be structured to detect different respective frequencies ω₁, ω₂, . . . ω_{N.} The entangled photons that remained above the surface 604 may be transmitted to the detectors 640-1, 640-2, . . . 640-N via an optical fiber 636. The coupling to the detectors 640-1, 640-2, . . . 640-N can include an optical delay coil 637. The optical delay coil 637 provides a delay mechanism to delay propagation of photons at the surface until the photons to which they are entangled have propagated through to location downhole at which to interacted with a chemical, if one is present and return back to the surface.

The optical fiber 660 disposed downhole may be coupled to a sensor 665. The sensor 665 can be designed to produce enhanced attenuation at a specific frequency, if the chemical is present. In addition or alternatively, the optical fiber 660 can be designed with a cladding that absorbs the chemical of interest such that propagation of photons having a frequency at the absorb frequency of the chemical can be absorbed providing a detection mechanism exhibited by measuring the photons directed to detectors 640-1, 640-2, . . . 640-N. The sensor 665 may be one of a plurality of sensors disposed downhole to provide measurements at different locations. Furthermore, the sensor 665 that allows the photon to interact with the chemical of interest, could be structured to provide the return photon that is transmitted or reflected by the sensing region. The return photon maybe transmitted by the same fiber or a different fiber. Additionally the sensor 665 could be a Bragg grating that reflects or transmits photons of specific frequency corresponding to the chemical of interest, when the chemical is present. The Bragg grating may be a fiber Bragg grating (FBG). The returned photon is detected by the detector 640-0 on the surface to monitor its presence or absence. The output of all the detectors 640-0, 640-1, . . . 640-N is analyzed with an analyzer 650 to provide statistics of the photons detected, and find correlations between the photon that is returned from downhole and the other photon of the entangled pair that is retained on the surface. The optical fiber 660 structured as a sensing optical fiber may be arranged to sense one or more chemicals at different locations along the length of the optical fiber 660 in the well 606, for example, with the optical fiber 660 being composed of a number of optical fiber sections.

A sensing scheme such as scheme 600 may have a number of meritorious features. The sensing scheme 600 may allow for absolutely zero downhole electronics, detection, or processing. The sensing scheme may be realized having only a single fiber going from the surface to the sensing location. A second fiber may be located on the surface. Alternatively, the surface fiber may be replaced by an optical delay circuit. The sensing scheme may be extended to detect more than one chemical and also to detect one or more chemicals at different locations. Use of the entangled photons can be used over relatively large depths of boreholes at a well site, as an entangled photon in the telecom band has been demonstrated to travel several 10 s of Kms.

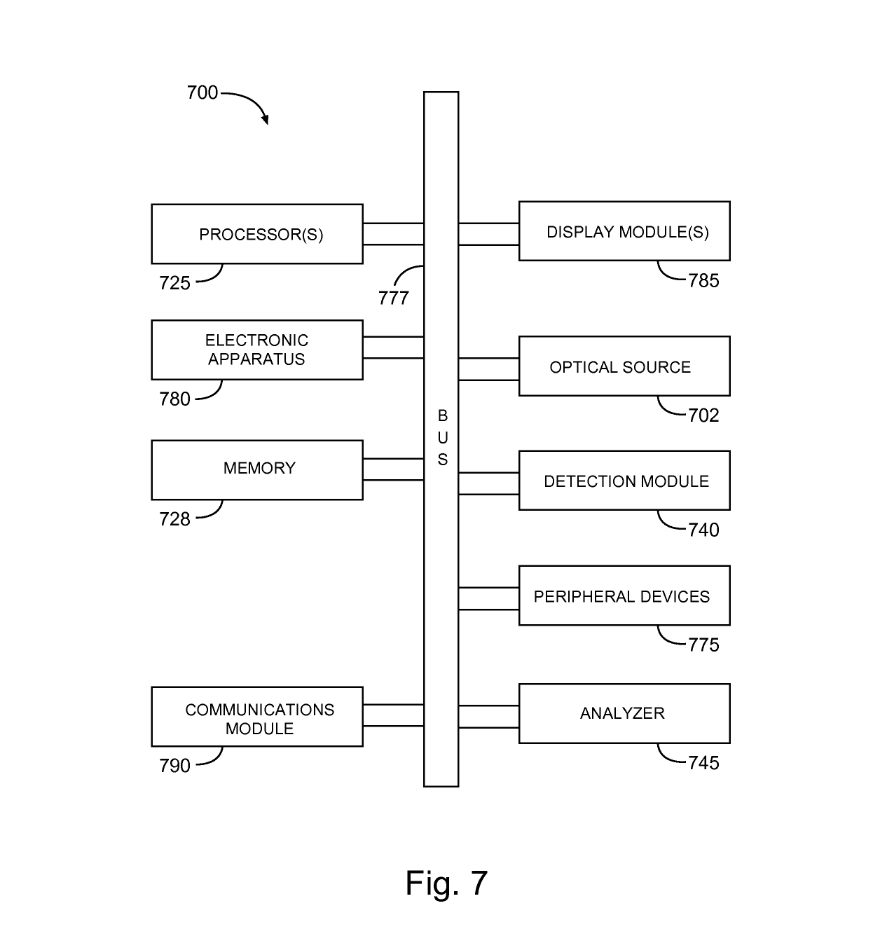

FIG. 7 is a block diagram of an embodiment of an example system 700 that is operable as a measurement system using entangled photons. System 700 includes an optical source 702 and a detection module 740, where the optical source 702 provides entangled photons that can be used to sense an entity such as a chemical according to any of the teachings herein. Optical source 702 may be arranged as a source of photons, such as a pump laser, and an entanglement source. Signals received at the detection module 740 can be operated on by an analyzer 745. Analyzer 745 may provide statistics regarding photons detected at detection module 740 as taught herein. The system 700 can also include a one or more processors 725, a memory 728, an electronic apparatus 780, and a communications module 740.

The one or more processors 725, the memory 728, and the communications module 740 can be arranged to operate as a processing unit to control operation of the optical source 702 and the detection module 740, in a manner similar or identical to the procedures discussed herein. Such a processing unit may be realized using the analyzer 745, which can be implemented as a single unit or distributed among the components of system 700 including electronic apparatus 780. The one or more processors 725 and the memory 728 can operate to control activation of the optical source 702 and collection of signals from the detection module 740. The system 700 can be structured to function in a manner similar to or identical to structures associated with FIGS. 1-6.

The system 700 can also include a bus 777, where the bus 777 provides electrical and/or optical connectivity among the components of the system 700. The bus 777 can include an address bus, a data bus, and a control bus, each independently structured or in an integrated format. The bus 777 can be realized using a number of different communication mediums that allows for the distribution of components of system 700. Use of bus 777 can be regulated by the one or more processors 725.

In various embodiments, peripheral devices 775 can include additional storage memory and/or other control devices that may operate in conjunction with the one or more processors 725 and/or the memory 728. In an embodiment, the one or more processors 725 can be realized as a processor or a group of processors that may operate independently depending on an assigned function. The peripheral devices 775 can be arranged with one or more displays that can be used with instructions stored in the memory 728 to implement a user interface to monitor the operation of components distributed within the system 700. The user interface can be used to input parameter values to operate the system 700.

At present, chemical sensing using fiber optics downhole in a conventional manner is considered to be a difficult task requiring instruments to be present downhole. Methods identical or similar to methods taught herein may provide extremely low cost alternative structures and procedures, since in one embodiment only a single fiber with passive sensor may be installed downhole. All processing and measurement can be conducted on the surface. Furthermore, even the surface processing may be minimal, involving only photon detectors. Such techniques as taught herein may provide enhancements in cost and reliability, sensitivity, and accuracy. Also, the use of entangled photons provide advantage over laser light by allowing detection in the presence of noise and loss of photons. Further, such techniques can provide a quantum-leap for chemical sensing within the oil and gas industry. In addition, such techniques generate a new paradigm in chemical sensing.

Although specific embodiments have been illustrated and described herein, it will be appreciated by those of ordinary skill in the art that any arrangement that is calculated to achieve the same purpose may be substituted for the specific embodiments shown. Various embodiments use permutations and/or combinations of embodiments described herein. It is to be understood that the above description is intended to be illustrative, and not restrictive, and that the phraseology or terminology employed herein is for the purpose of description. Combinations of the above embodiments and other embodiments will be apparent to those of skill in the art upon studying the above description.

What is claimed is:

1. A system comprising:
a source of photons;
an entanglement device arranged to receive the photons and to generate entangled pairs of photons, entangled with respect to a characteristic of the photons;
a first detector;
a splitter to send photons of the entangled pairs in a direction to sense a chemical and to send other photons to the first detector;
a second detector to detect the presence or absence of the return photon after interacting with the chemical; and
an analyzer to determine statistics of photons detected at the first and second detectors and to identify presence or absence of the chemical from the statistics.

2. The system of claim 1, wherein the characteristic of the photons is polarization of the photons and the first and second detectors are operable to detect polarization of received photons, the second detector detecting the returned photon after interacting with the chemical operable to detect at the least the presence absence of the photon.

3. The system of claim 1, wherein the characteristic of the photons is frequency of the photons and the first detector is operable to detect frequency of received photons, the second detector detecting the returned photon after interacting with the chemical operable to detect at least only the presence absence of the photon.

4. The system of claim 1, wherein the system includes an optical fiber to propagate the photons of the entangled pairs in the direction to sense the chemical.

5. The system of claim 4, wherein the system includes an optical fiber arranged to propagate the other photons to the first detector.

6. The system of claim 4, wherein the optical fiber is disposed downhole in a well to sense the presence or absence of the chemical in the well.

7. The system of claim 6, wherein cladding of the optical fiber at a location of sensing is structured to adsorb the chemical such that photons of a frequency corresponding to the chemical are loss.

8. The system of claim 6, wherein the system includes a sensor disposed downhole and coupled to the optical fiber, the sensor structured to produce attenuation at a specific frequency if the chemical is present, the specific frequency being a frequency of the photons of the frequency entangled pairs sent in a direction to sense the chemical.

9. The system of claim 6, wherein the system includes a sensor disposed downhole and coupled to the optical fiber, the sensor being a fiber Bragg grating structured reflect or transmit specific frequency if the chemical is present, the specific frequency being a frequency of the photons of the frequency entangled pairs sent in a direction to sense the chemical.

10. The system of claim 1, wherein identification of the presence or the absence of the chemical from the statistics includes a calculation of a probability of detected photons having a frequency different from those of the frequency attenuated by the chemical.

11. The system of claim 1, wherein the system includes a delay structure arranged to delay propagation of the other photons to the detector for a period to permit interaction of the chemical, if present, with the photons sent in the direction to sense the chemical, the direction from a surface of the earth, and returned back to the surface prior to detection.

12. The system of claim 1, wherein the entanglement device is structured to generate frequency entangled pairs of photons with a plurality of different pairs of frequencies, at least one pair of frequencies correlated to identifying presence or absence of a chemical different from a chemical identified using one of the other entangled pairs of photons.

13. A method comprising:
generating entangled pairs of photons with respect to a characteristic of the photons;
sending one photon of each entangled pair in a direction to sense a chemical downhole below earth surface;
sending another photon of each entangled pair to a first detector on the earth surface;
detecting, at a second detector, the photon after it has returned back to the earth surface after interacting with the chemical;
recording statistics of photons detected at the first and second detectors;
analyzing photon correlations between the photon of the entangled pair sent to the first detector on the earth surface, and the other photon that was sent downhole and returned back to the earth surface; and
identifying presence or absence of the chemical from the statistics.

14. The method of claim 13, wherein generating entangled pairs of photons includes generating entangled pairs of photons with respect to polarization.

15. The method of claim 13, wherein recording statistics of photons detected at the first and second detectors includes determining the number of photons detected that have a specific frequency with respect to the total number of photons detected.

16. A method comprising:
generating frequency entangled pairs of photons;
sending one of the photons of each frequency entangled pair in a direction to sense a chemical;
detecting the photon, sent in the direction to sense the chemical, after it has passed through a region where the presence of the chemical is to be detected;
sending other photons of the frequency entangled pairs to a detector;
recording statistics of photons detected at the detector; and
identifying presence or absence of the chemical from the statistics.

17. The method of claim 16, wherein sending photons of the frequency entangled pairs in the direction to sense the chemical includes sending the photons into an optical fiber disposed downhole in a well from earth surface in the direction to sense the chemical; and guiding the transmitted or reflected photon from a sensing region back to the earth surface via the same fiber or a different fiber using a circulator or a coupler to guide the photon back to the earth surface.

18. The method of claim 17, wherein cladding of the optical fiber at a location of sensing is structured to adsorb the chemical such that photons of a frequency corresponding to the chemical are loss.

19. The method of claim 17, wherein sending the photons into the optical fiber includes sending the photons to a sensor disposed downhole and coupled to the optical fiber, the sensor structured to produce enhanced attenuation at a specific frequency if the chemical is present, the specific frequency being a frequency of the photons of the frequency entangled pairs sent in a direction to sense the chemical.

20. The method of claim 16, wherein identifying the presence or the absence of the chemical from the statistics includes calculating a probability of detected photons having a frequency different from frequency attenuated by the chemical.

21. The method of claim 16, wherein sending the other photons to the detector includes delaying the propagation of the other photons to the detector for a period to permit interaction of the chemical, if present, with the photons sent in the direction to sense the chemical, the direction being below a surface of the earth, and returned back to the surface prior to detection.

22. The method of claim 21, wherein delaying the propagation includes sending the other photons to the detector using an optical delay coil.

23. The method of claim 21, wherein delaying the propagation includes producing the delay by slowing the other photons down using a slow light device.

24. The method of claim 23, wherein the slow light device uses a nonlinear interaction.

25. The method of claim 21, wherein delaying the propagation includes sending the other photons to the detector using an optical memory.

26. The method of claim 25, wherein the optical memory is a cavity or a solid state memory.

27. The method of claim 16, wherein generating frequency entangled pairs of photons includes generating frequency entangled pairs of photons with a plurality of different pairs of frequencies, at least one pair of frequencies correlated to identifying presence or absence of a chemical different from a chemical identified using one of the other entangled pairs of photons.
